(19) United States
(12) Patent Application Publication
(10) Pub. No.: US 2010/0088687 A1
(43) Pub. Date: Apr. 8, 2010

(54) Variable Length Code Table Clustering Method, and Method and Apparatus for Sharing Memory of Multi-Codec by Using the Variable Length Code Table Clustering Method

(75) Inventors: Ki Young Choi, Seoul (KR); Venkata Krishna Prasad Arava, Kyeonggi-do (KR); Ki Wook Yoon, Seoul (KR); Hyouk Joong Lee, Seoul (KR); Man Hwee Jo, Seoul (KR)

Correspondence Address: FISH & RICHARDSON, PC, P.O. BOX 1022, MINNEAPOLIS, MN, 55440-1022, US

(73) Assignees: Core Logic, Inc., Seoul (KR); SNU R&DB Foundation, Seoul (KR)

(21) Appl. No.: 12/420,633

(22) Filed: Apr. 8, 2009

(30) Foreign Application Priority Data
Oct. 7, 2008 (KR) 1020080098324

(51) Int. Cl. G06F 9/45; G06F 12/00; G06F 12/02

(52) U.S. Cl. 717/151; 711/147; 711/170; 711/E12.001; 711/E12.002

(57) ABSTRACT

Provided are a method and apparatus for sharing a memory of a multi-codec. For each of a plurality of codecs, the method and apparatus cluster a variable length code tree into a plurality of groups whereby a level difference between symbols in each group of the plurality of groups is less than a predetermined value, wherein the variable length code tree corresponds to at least one of variable length code tables for each of the plurality of codecs, refer to maximum levels of the symbols in each group of the plurality of groups, and determine a storage capacity of an internal memory shared between the variable length code tables for the plurality of codecs.

### CLAIM OF PRIORITY

This application claims priority under 35 USC §119 to Korean Patent Application No. 10-2008-0098324, filed on 7 Oct. 2008, In the Korean Intellectual Property Office, the entire contents of which are hereby incorporated by reference.

### BACKGROUND

The present disclosure relates to sharing a memory, and more particularly, to variable length code table clustering method.

Due to the growth in multimedia communications and mobile convergence, the portable multimedia applications market has rapidly expanded. Such multimedia applications perform digital transmission of still images, moving pictures, and audio files including mass data. Thus, in order to perform lossless compression of the mass data, variable length coding is widely used in multimedia applications.

A representative example of such variable length coding is Huffman coding. A Huffman code is a type of variable length code capable of lessening an average length of codes in digital transmission. Due to its easy implementation and high compression efficiency, the Huffman code is widely used in various data compression processes, in particular, in Joint Photographic Experts Group (JPEG), Moving Picture Expert Group (MPEG)-1, MPEG-2, MPEG-4, and the like, which are image or video compression standards.

A multi-codec is a system that includes a plurality of codes in one hardware chip, wherein the codes support various compression standards such as JPEG, MPEG-1, MPEG-2, MPEG-4, etc. Each of the plurality of codecs performs data encoding/decoding by using variable length code tables (e.g., a Huffman code table) that are individually defined to support related standards. In this case, each of the plurality of codes has read-only memory (ROM)/random access memory (RAM) resources so as to control the variable length code tables.

### SUMMARY

The present disclosure provides a method and apparatus for sharing a memory, and a computer readable recording medium having recorded thereon a program for executing the method so that a memory space for storing variable length code tables for a plurality of codecs can be shared in a multi-codec, and memory resources can be efficiently used in the multi-codec.

According to an aspect of the present disclosure, there is provided a method of sharing a memory of a multi-codec, the method including, for each of a plurality of codecs, the operations of clustering a variable length code tree into a plurality of groups whereby a level difference between symbols in each group of the plurality of groups is less than a predetermined value, wherein the variable length code tree corresponds to at least one of variable length code tables for each of the plurality of codecs; and referring to maximum levels of the symbols in each group of the plurality of groups, and determining a storage capacity of an internal memory shared between the variable length code tables for the plurality of codecs.

The method may further include the operations of comparing bit-lengths of the symbols for each of the plurality of codecs; and selecting a codec having a symbol with a longest bit-length from among the bit-lengths according to a result of the comparing. Here, the operation of determining the storage capacity may include the operations of referring to the maximum levels of the symbols in each group of the plurality of groups and referring to the bit-length of the symbol for the selected codec, thereby determining the storage capacity of the internal memory.

According to another aspect of the present disclosure, there is provided a computer readable recording medium having recorded thereon a program for executing a method of sharing a memory of a multi-codec, the method including, for each of a plurality of codecs, the operations of clustering a variable length code tree into a plurality of groups whereby a level difference between symbols in each group of the plurality of groups is less than a predetermined value, wherein the variable length code tree corresponds to at least one of variable length code tables for each of the plurality of codecs; and referring to maximum levels of the symbols in each group of the plurality of groups, and determining a storage capacity of an internal memory shared between the variable length code tables for the plurality of codecs.

According to another aspect of the present disclosure, there is provided a multi-codec memory sharing apparatus including a clustering unit, for each of a plurality of codecs, clustering a variable length code tree into a plurality of groups whereby a level difference between symbols in each group of the plurality of groups is less than a predetermined value, wherein the variable length code tree corresponds to at least one of variable length code tables for each of the plurality of codecs; and a memory storage capacity determining unit referring to maximum levels of the symbols in each group of the plurality of groups, and determining a storage capacity of an internal memory shared between the variable length code tables for the plurality of codecs.

According to another aspect of the present disclosure, there is provided a method of clustering a variable length code table, the method including the operations of selecting a variable length code table from among a plurality of variable length code tables; and clustering a variable length code tree into a plurality of groups whereby a level difference between symbols in each group of the plurality of groups is less than a predetermined value, wherein the variable length code tree corresponds to the selected variable length code table.

According to another aspect of the present disclosure, there is provided a computer readable recording medium having recorded thereon a program for executing a method of clustering a variable length code table, the method including the operations of selecting a variable length code table from among a plurality of variable length code tables; and clustering a variable length code tree into a plurality of groups whereby a level difference between symbols in each group of the plurality of groups is less than a predetermined value, wherein the variable length code tree corresponds to the selected variable length code table.

According to another aspect of the present disclosure, there is provided a method of controlling a memory, the method including the operations of selecting a variable length code table from among a plurality of variable length code tables; clustering a variable length code tree into a plurality of groups whereby a level difference between symbols in each group of the plurality of groups is less than a predetermined value, wherein the variable length code tree corresponds to the selected variable length code table; and referring to the plurality of groups and determining a storage capacity of a memory for storing the plurality of variable length code tables. According to another aspect of the present disclosure, there is provided a computer readable recording medium having recorded thereon a program for executing a method of controlling a memory, the method including the operations of selecting a variable length code table from among a plurality of variable length code tables; clustering a variable length code tree into a plurality of groups whereby a level difference between symbols in each group of the plurality of groups is less than a predetermined value, wherein the variable length code tree corresponds to the selected variable length code table; and referring to the plurality of groups and determining a storage capacity of a memory for storing the plurality of variable length code tables; and referring to the plurality of groups and determining a storage capacity of a memory for storing the plurality of variable length code tables.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a block diagram of a multi-codec according to an embodiment of the present disclosure;

FIG. 2 is a detailed block diagram of a first processor included in the multi-codec of FIG. 1;

FIG. 3 is a detailed block diagram of the multi-codec memory sharing device 30 included in the multi-codec of FIG. 1;

FIG. 4A is an example of a Huffman code tree;

FIG. 4B illustrates a Huffman code table corresponding to the Huffman code tree of FIG. 4A;

FIG. 5A illustrates the Huffman code tree of FIG. 4A that is clustered by using a first clustering mode, according to an embodiment of the present disclosure;

FIG. 5B is a table showing efficiencies of first, second, and third clustered groups of FIG. 5A;

FIG. 6A is illustrates the Huffman code tree of FIG. 4A that is clustered by using a second clustering mode, according to another embodiment of the present disclosure;

FIG. 6B is a table showing efficiencies of first, second, and third clustered groups of FIG. 6B;

FIGS. 7A and 7B are tables showing results obtained by a clustering unit of FIG. 3, which clusters Huffman code tables for Moving Picture Expert Group (MPEG)-4;

FIGS. 8A through 8C are tables showing results obtained by the clustering unit of FIG. 3, which clusters Huffman code tables for the H.264 standard; and

FIG. 9 is a flowchart of a method of sharing a memory of a multi-codec, according to another embodiment of the present disclosure.

### DETAILED DESCRIPTION

The present disclosure will now be described more fully with reference to the accompanying drawings, in which exemplary embodiments of the disclosure are shown. Like reference numerals in the drawings denote like elements.

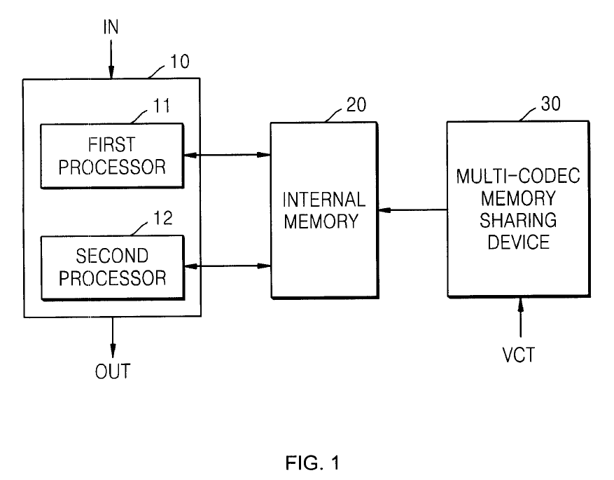

FIG. 1 is a block diagram of a multi-codec according to an embodiment of the present disclosure.

Referring to FIG. 1, the multi-codec includes a processing unit 10, an internal memory 20 and a multi-codec memory sharing device 30. In the embodiment of FIG. 1, the internal memory 20 may be embodied as a random access memory (RAM).

The processing unit 10 includes two processors 11 and 12 which respectively support a plurality of standards. The plurality of standards may be Joint Photographic Experts Group (JPEG), Moving Picture Expert Group (MPEG)-4 (MPEG-4), H.264, etc. In the embodiment of FIG. 1, the two processors 11 and 12 that are first and second processors 11 and 12 of the processing unit 10 may respectively support the MPEG-4 and H.264 standards. Also, the processing unit 10 may further include a third processor (not shown) supporting JPEG. However, it will be understood by one of ordinary skill in the art that the embodiment of FIG. 1 is not limited thereto and thus may further include other processors supporting other standards.

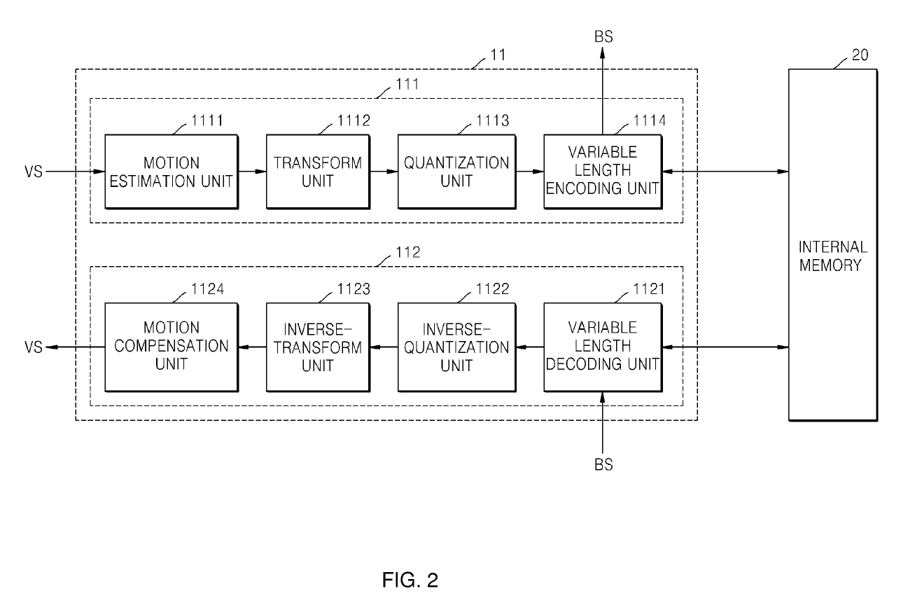

FIG. 2 is a detailed block diagram of the first processor 11 included in the multi-codec of FIG. 1.

Referring to FIG. 2, the first processor 11 includes an encoding unit 111 and a decoding unit 112.

The encoding unit 111 includes a motion estimation unit 1111, a transform unit 1112, a quantization unit 1113, and a variable length encoding unit 1114. The motion estimation unit 1111 receives a video sequence (VS), and performs motion estimation. The transform unit 1112 receives an output of the motion estimation unit 1111, and transforms the output into the frequency domain. The quantization unit 1113 performs lossless encoding to the output, and outputs a variable length bitstream (BS).

The decoding unit 112 includes a variable length decoding unit 1121, an inverse-quantization unit 1122, an inverse-transform unit 1123, and a motion compensation unit 1124. The variable length decoding unit 1121 receives a BS, and performs lossless decoding on the BS. The inverse-quantization unit 1122 performs inverse-quantization on an output of the variable length decoding unit 1121. The inverse-transform unit 1123 inverse-transforms an output of the inverse-quantization unit 1122 into the time domain. The motion compensation unit 1124 performs motion compensation on an output of the inverse-transform unit 1123, and outputs a VS.

Here, the variable length encoding unit 1114 and the variable length decoding unit 1121 refer to a variable length code table, thereby respectively performing encoding and decoding of data. Hereinafter, it is assumed that the variable length encoding unit 1114 and the variable length decoding unit 1121 respectively perform encoding and decoding of data by referring to a Huffman code table. However, it will be understood by one of ordinary skill in the art that the embodiment of FIG. 1 is not limited thereto and thus may perform encoding and decoding by referring to other variable length code tables.

Referring to FIG. 2, a structure and an operation of the first processor 11 is described but a structure and an operation of the second processor 12 is similar to those of the first processor 11. Also, the second processor 12 performs encoding and decoding of data by referring to a variable length code table such as the Huffman code table.

Referring back to FIG. 1, the internal memory 20 stores a variable length code table that is referred to by a currently operating processor from among the first and second processors 11 and 12 so as to perform encoding and decoding of data. To be more specific, the multi-codec pre-stores variable length code tables, which are respectively for a plurality of codecs, in an external memory (not shown) such as a read-only memory (ROM) having a large storage capacity.

In the case where data transmission is performed according to the MPEG-4 standard, in other words, when the first processor 11 is operated, the multi-codec loads variable length code tables into the internal memory 20, and performs encoding and decoding of data according to the MPEG-4 standard, wherein the variable length code tables are for the MPEG-4 standard and are pre-stored in the external memory. Meanwhile, in the case where data transmission is performed according to the H.264 standard, in other words, when the second processor 12 is operated, the multi-codec loads variable length code tables to the internal memory 20, and performs encoding and decoding of data according to the H.264 standard, wherein the variable length code tables are for the H.264 standard and are pre-stored in the external memory.

A conventional multi-codec has Huffman code tables which are independently aimed at a plurality of codecs, and the size of each Huffman code table varies from several kilobytes to several hundreds of kilobytes according to the type of Huffman code table. The Huffman code tables, which are respectively used by the plurality of codecs, are mutually different in terms of the number of tables to be used, the number of symbols to be represented in each table, and the bit lengths of symbols, thus, each of the plurality of codecs has an individually specialized Huffman code table. Accordingly, in such a conventional multi-codec, the number of the Huffman code tables has to be equal to the number of codec types, and whenever a new codec is added, a new memory is required to store a new Huffman code table such that resources cannot be efficiently used, and a hardware area in a total system increases.

In the embodiment of FIG. 1, Huffman code tables, which are basically based on a same Huffman coding algorithm but are independently treated for each codec due to a difference between detailed contents of tables, are shared in an internal memory. By doing so, resources of the multi-codec may be efficiently used, and a size of a total system may be reduced.

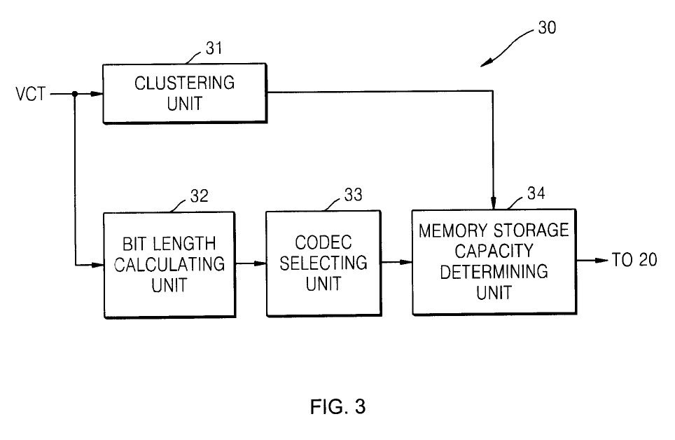

FIG. 3 is a detailed block diagram of the multi-codec memory sharing device 30 included in the multi-codec of FIG. 1.

Referring to FIG. 3, the multi-codec memory sharing device, that is, an apparatus for sharing the memory of the multi-codec includes a clustering unit 31, a bit length calculating unit 32, a codec selecting unit 33, and a memory storage capacity determining unit 34. Such a multi-codec memory sharing apparatus is applied to the multi-codec of FIG. 1, and sets a storage capacity of the internal memory 20 included in the multi-codec before data transmission is performed, so that variable length code tables for a plurality of codecs are shared in the internal memory 20.

The clustering unit 31 receives at least a variable length code table for a codec from among the plurality of codecs, and clusters a variable length code tree, which corresponds to the variable length code table, into a plurality of groups. Here, it will be understood by one of ordinary skill in the art that the term ‘group’ has the same meaning as the terms “cluster”, “partition”, etc., and the term ‘clustering’ has the same meaning as the terms “grouping”, “partitioning”, etc.

To be more specific, the clustering unit 31 clusters the variable length code tree into the plurality of groups so that a level difference between symbols in each group is less than a predetermined value. For example, the clustering unit 31 may cluster the variable length code tree into the plurality of groups so that the level difference between the symbols in each group is equal to or less than 1. By doing so, a time required to search the symbols in each group may be limited to maximum 2 cycles, so that a decoding speed may be constantly maintained. However, the embodiment of FIG. 3 is not limited thereto and thus may have different values for the level difference between the symbols in each group.

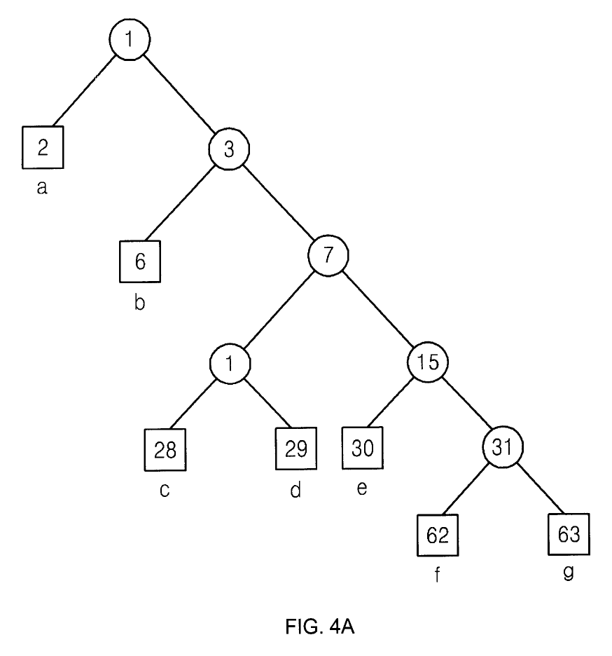

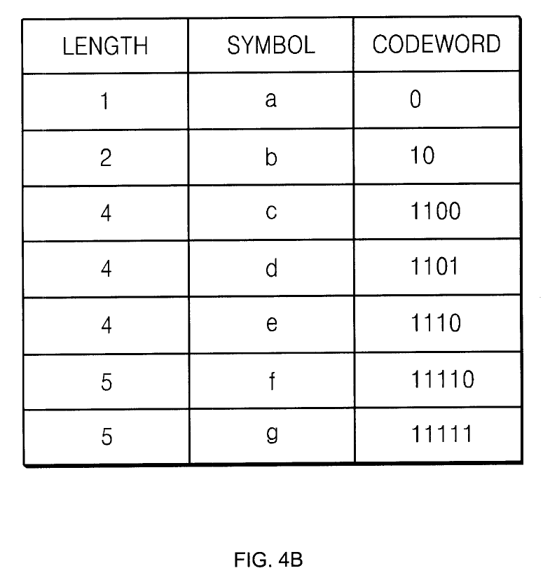

Hereinafter, operations of the clustering unit 31 will be described in detail by referring to FIGS. 4A through 6B.

FIG. 4A is an example of a Huffman code tree.

FIG. 4B illustrates a Huffman code table corresponding to the Huffman code tree of FIG. 4A.

Referring to FIGS. 4A and 4B, as an example of the Huffman code tree, a single-side growing Huffman (SGH) tree is shown, wherein the SGH tree has five levels and is a type of a binary search tree. The binary search tree is a binary data structure that starts at a root node, moves a node to a left sub-node when an input bit is 0 or moves the node to a right sub-node when the input bit is 1 so as to perform examination bit by bit, and continues to perform the examination until a leaf node is reached. Each symbol is mapped with a leaf node of a tree, and a codeword for each symbol is determined according to a path from a root of the tree to the leaf node. Here, codewords are applied to the SGH tree in such a manner that a shape of its binary search tree is directed towards one side of the tree.

A symbol a exists at a first level, and has a length 1 and a codeword 0. A symbol b exists at a second level, and has a length 2 and a codeword 10. A symbol c exits at a fourth level, and has a length 4 and a codeword 1100. A symbol d exists at the fourth level, and has a length 4 and a codeword 1101. A symbol e exists at the fourth level, and has a length 4 and a codeword 1110. A symbol f exists at a fifth level, and has a length 5 and a codeword 11110. A symbol g exists at the fifth level, and has a length 5 and a codeword 11111.

In this manner, the Huffman code table generally has a tree structure, and in such a tree structure, a symbol search technique is classified into a bit serial technique and a lookup table technique. The bit serial technique does not require a large capacity memory to store a Huffman code table but it takes a long time to search for a symbol, that is, the bit serial technique has a long cycle. Meanwhile, the lookup table technique requires a cycle to search for a symbol but it needs a large capacity memory to store a Huffman code table.

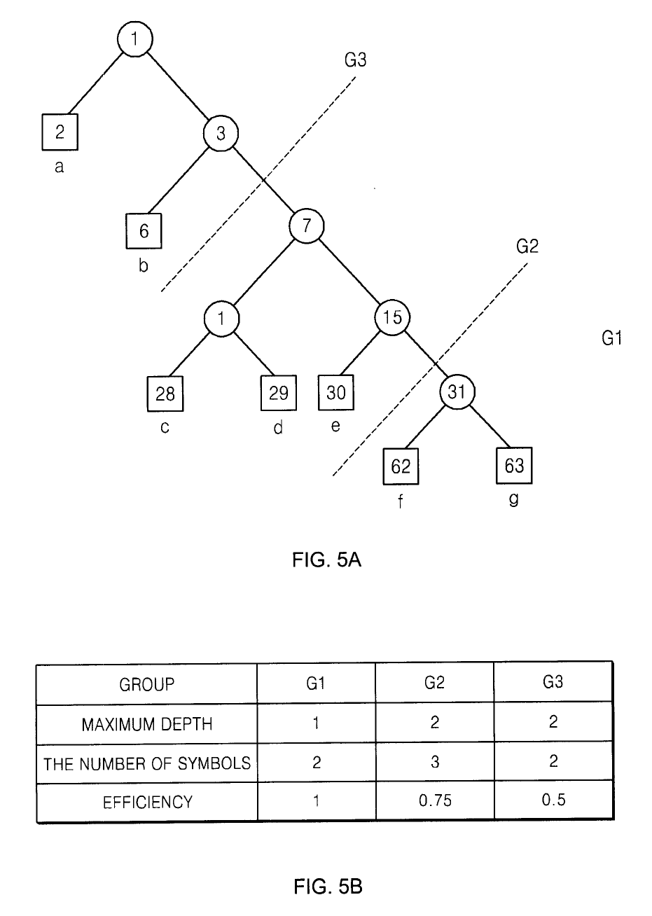

FIG. 5A illustrates the Huffman code tree of FIG. 4A that is clustered by using a first clustering mode, according to an embodiment of the present disclosure.

Referring to FIG. 5A, as denoted using dotted lines, the first clustering mode according to the embodiment of FIG. 5A clusters the Huffman code tree into three groups that are first, second, and third groups G1, G2, and G3. The first group G1 includes symbols f and g which exist at a fifth level. Here, levels of the symbols f and g included in the first group G1 are the same fifth level, thus, a level difference between the symbols f and g is 0. The second group G2 includes symbols c, d, and e which exist at a fourth level. Here, levels of the symbols c, d, and e included in the second group G2 are the same fourth level, thus, a level difference between the symbols c, d, and e is 0. The third group G3 includes a symbol a existing at a first level, and a symbol b existing at a second level. Here, a level difference between the symbols a and b included in the third group G3 is 1. In this manner, the first clustering mode according to the embodiment of FIG. 5A may cluster the Huffman code tree into a plurality of groups so that a level difference between symbols included in each group of the Huffman code tree may be equal to or less than 1.

FIG. 5B is a table showing efficiencies of the first, second, and third clustered groups G1, G2, and G3 of FIG. 5A.

Referring to FIGS. 5A and 5B, memory efficiencies of each clustered group may be calculated by using Equation 1.

E=Ns/2^{k} [Equation 1]

where E represents the memory efficiency of each group, Ns represents the number of symbols in each group, and k represents a maximum level of each group. Here, the maximum level of each group is the same as a maximum depth of a binary tree in each group.

The maximum depth of the first group G1 is 1 and the number of symbols is 2 so that the memory efficiency of the first group G1 equals to 1 (=2/2¹). Also, the maximum depth of the second group G2 is 2 and the number of symbols is 3 so that the memory efficiency of the second group G2 equals to 0.75(=3/2²). The maximum depth of the third group G3 is 2 and the number of symbols is 2 so that the memory efficiency of the third group G3 equals to 0.5(=2/2²).

In this case, overall efficiency of the first, second, and third groups G1, G2, and G3, wherein the overall efficiency is used to determine efficiency of the first clustering mode, may be calculated by using Equation 2.

$$OE = TNs / TS = {\sum }_{i} {n}_{i} / {\sum }_{i} {2}^{{k}_{i}} \qquad [ Equation 2 ]$$

where OE represents the overall efficiency of a memory, TNs represents the total number of symbols, and TS represents a total storing space. Here, i represents an index of each group, nᵢ represents the number of symbols in an i^{th} group, and kᵢ represents a maximum level of a binary tree in an i^{th} group. According to Equation 2, the overall efficiency of the first clustering mode equals to 0.7 (=(2+3+2)/(2¹+2²+2²)

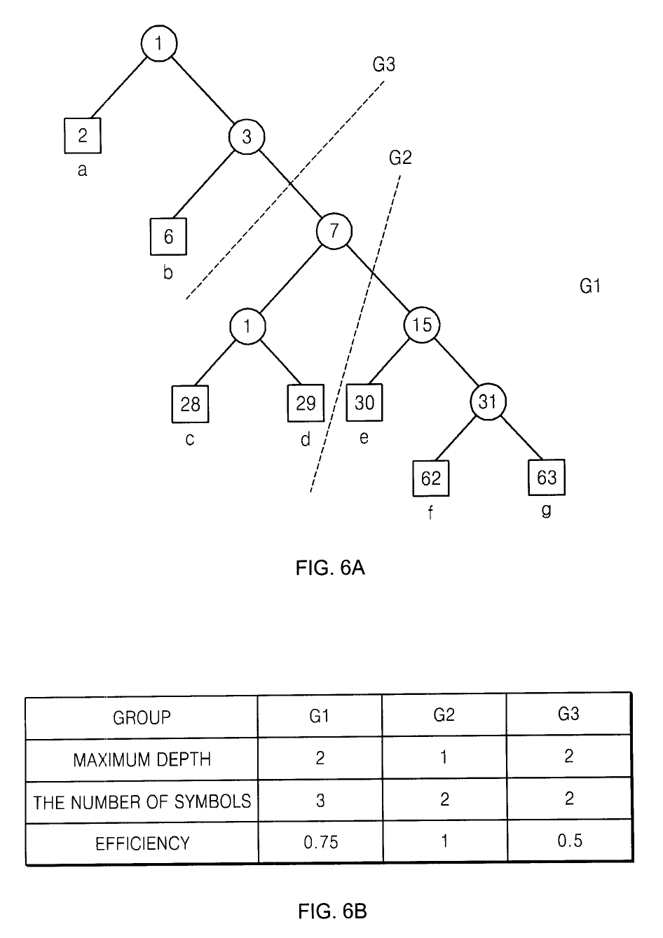

FIG. 6A is illustrates the Huffman code tree of FIG. 4A that is clustered by using a second clustering mode, according to another embodiment of the present disclosure.

Referring to FIG. 6A, as denoted using dotted lines, the second clustering mode according to the embodiment of FIG. 6A clusters the Huffman code tree into three groups that are first, second, and third groups G1, G2, and G3. The first group G1 includes a symbol e existing at a fourth level, and symbols f and g both existing at a fifth level. Here, a level difference between the symbols e, f, and g included in the first group G1 is 0 or 1. The second group G2 includes symbols c and d both existing at the fourth level. Here, levels of the symbols c and d included in the second group G2 are the same fourth level, thus, a level difference between the symbols c and d is 0. The third group G3 includes a symbol a existing at a first level, and a symbol b existing at a second level. Here, level difference between the symbols a and b included in the third group G3 is 1. In this manner, the second clustering mode according to the embodiment of FIG. 6A may cluster the Huffman code tree into a plurality of groups so that a level difference between symbols included in each group of the Huffman code tree may be equal to or less than 1.

FIG. 6B is a table showing efficiencies of the first, second, and third clustered groups G1, G2, and G3 of FIG. 6A.

Referring to FIGS. 6A and 6B, a maximum depth of the first group G1 is 2 and the number of symbols is 3 so that memory efficiency of the first group G1 according to the above shown Equation 1 equals 0.75(=3/2²). Also, the maximum depth of the second group G2 is 1 and the number of symbols is 2 so that the memory efficiency of the second group G2 equals 1(=2/2¹). The maximum depth of the third group G3 is 2 and the number of symbols is 2 so that the memory efficiency of the third group G3 equals 0.5(=2/2²). Also, according to the above shown Equation 2, overall efficiency of the second clustering mode equals 0.7 (=(3+2+2)/(2²+2¹+2²)).

Since the overall efficiency of the first clustering mode according to the embodiment of FIG. 5A is 0.7 that is the same as that of the overall efficiency of the second clustering mode according to the embodiment of FIG. 6A, the clustering unit 31 may cluster a Huffman code tree by using any one of the first clustering mode and the second clustering mode. However, as a result of clustering a Huffman code tree by using clustering modes which are different from each other, if overall efficiency varies according to the clustering modes, the clustering unit 31 clusters a Huffman code tree by using a clustering mode having a higher overall efficiency that that of the other clustering mode. Also, in other embodiments of the present disclosure, the clustering unit 31 may individually employ three or more clustering modes and may cluster a Huffman code tree by using a clustering mode having a highest overall efficiency from among the three or more clustering modes.

Referring back to FIG. 3, as described above, the clustering unit 31 generates a plurality of clustering modes with respect to a Huffman code tree, compares each overall efficiency of each generated clustering mode, and selects one of the plurality of clustering modes according to a result of the comparison. In another example embodiment of the present disclosure, the clustering unit 31 may cluster the Huffman code tree into a plurality of groups so that a level difference between symbols in each group may be less than a predetermined value without generating a plurality of clustering modes. Also, the clustering unit 31 performs the above described clustering operation for each of a plurality of codecs.

In this manner, the embodiment of FIG. 3 may cluster a Huffman code tree into a plurality of groups that are clusters, thereby enabling the bit serial technique and the lookup table technique to be complemented. Accordingly, it is possible to reduce a time required to search for a symbol, and to lessen a memory capacity and a hardware size.

Meanwhile, the clustering modes for clustering a Huffman code tree according to the embodiments of FIGS. 5A and 6A are not limited to the multi-codec. In other embodiments of the present disclosure, a method of clustering a Huffman code tree may be applied to a single-codec. Since the single-codec includes a plurality of Huffman code tables, the method may cluster a Huffman code tree corresponding to each of the Huffman code tables and may control a storage capacity of a memory in the single-codec.

Hereinafter, the clustering unit 31 will be described in detail by using its clustering operation with respect to Huffman code tables respectively used for the MPEG-4 and H.264 standards.

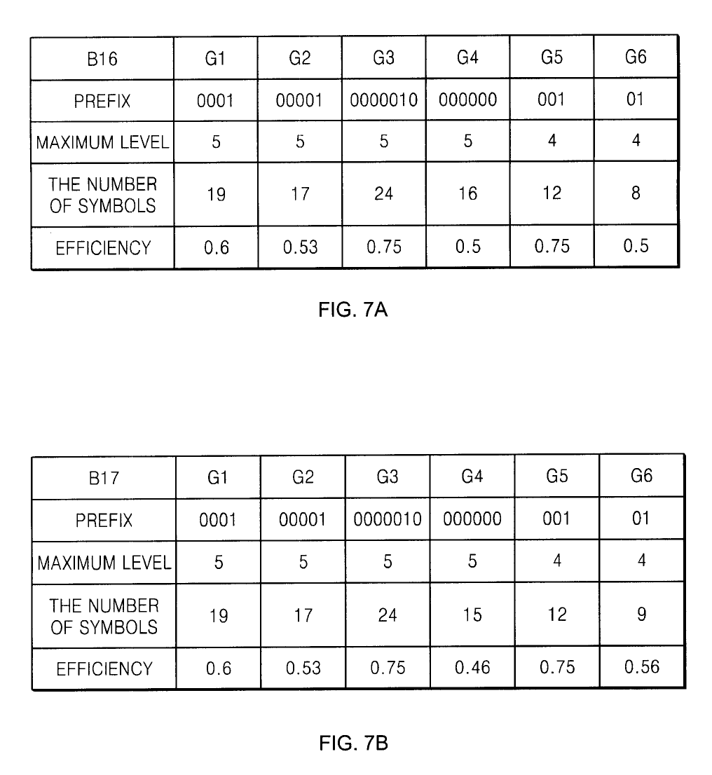

FIGS. 7A and 7B are tables showing results obtained by the clustering unit 31 of FIG. 3 which clusters Huffman code tables for the MPEG-4 standard.

Referring to FIGS. 3, 7A, and 7B, the clustering unit 31 clusters a Huffman code tree into a plurality of groups, wherein the Huffman code tree corresponds to at least one of the Huffman code tables for the MPEG-4 standard. For example, the clustering unit 31 clusters B16 and B17 into a plurality of groups, wherein B16 and B17 are Huffman code tables primarily used for the MPEG-4 standard. Here, B16 is a table that is used for encoding and decoding intra-frames, and B17 is a table that is used for encoding and decoding inter-frames.

The clustering unit 31 clusters a Huffman code tree corresponding to the B16 into six groups G1 through G6, and also clusters a Huffman code tree corresponding to the B17 into six groups G1 through G6.

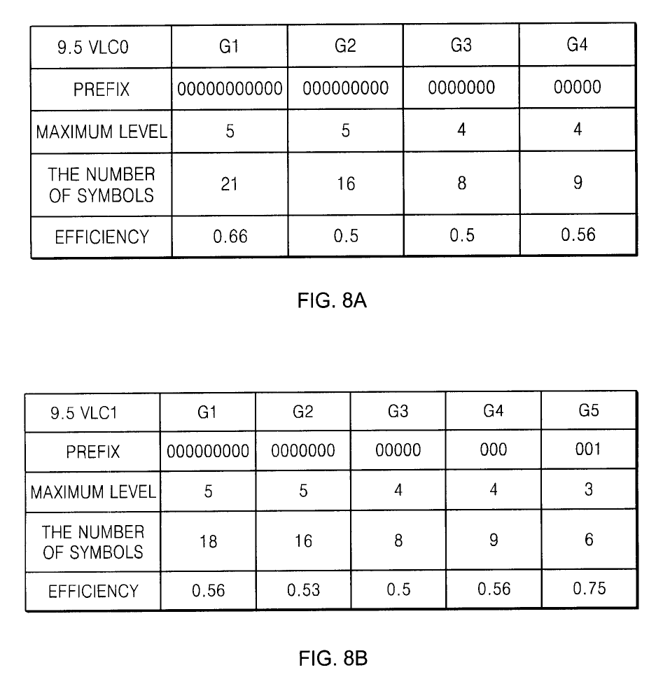

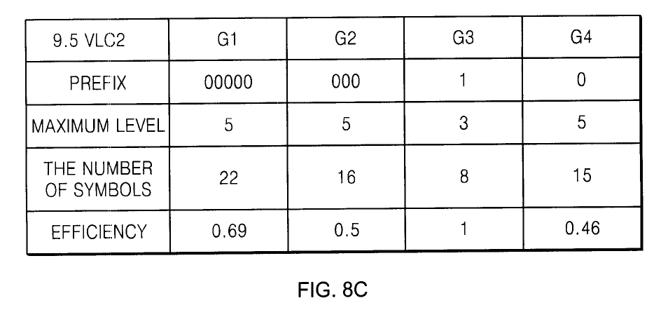

FIGS. 8A through 8C are tables showing results obtained by the clustering unit 31 of FIG. 3 which clusters Huffman code tables for the H.264 standard.

Referring to FIGS. 3, and 8A through 8C, the clustering unit 31 clusters a Huffman code tree into a plurality of groups, wherein the Huffman code tree corresponds to at least one of the Huffman code tables for the H.264 standard. For example, the clustering unit 31 clusters frequently used Huffman code tables that are 9.5 variable length code (VLC)0, 9.5 VLC1, and 9.5 VLC2 into a plurality of groups. Here, the 9.5 VLC0, the 9.5 VLC1, the 9.5 VLC2, and 9.5 VLC3 are tables which are used to encode Coeff_token, and one of the 9.5 VLC0, the 9.5 VLC1, the 9.5 VLC2, and the 9.5 VLC3 is selectively used to encode Coeff_token according to the number of coefficients. Here, a token is the sum total of the number of non-zero coefficients and the number of trailing 1s (ones). At this time, since the 9.5 VLC3 has a code having a fixed length, the clustering unit 31 does not perform a clustering operation on the 9.5 VLC3.

The clustering unit 31 clusters a Huffman code tree corresponding to the 9.5 VLC0 into four groups G1 through G4, as illustrated in FIG. 8A, clusters a Huffman code tree corresponding to the 9.5 VLC1 into five groups G1 through G5 as illustrated in FIG. 8B, and clusters a Huffman code tree corresponding to the 9.5 VLC2 into four groups G1 through G4 as illustrated in FIG. 8C.

Referring back to FIG. 3, the bit length calculating unit 32 calculates a bit-length of a symbol for each codec. Here, it will be understood by one of ordinary skill in the art that the bit-length is used in the same manner as a bit-width. For example, in the case of the MPEG-4 standard, 11 bits are required to exhibit symbol contents that are last, run, and level, and 2 bits of control bits are added to the 11 bits so that an internal memory having in total a 13 bit-length is necessary. For example, the internal memory may be a RAM. Meanwhile, in the case of the H.264 standard, 7 bits are required to exhibit symbol contents that are the number of coefficients and the number of trailing 1s (ones), and 2 bits of control bits are added to the 7 bits so that an internal memory having in total a 9 bit-length is necessary. For example, the internal memory may be a RAM. In other words, a bit-length of a symbol for the MPEG-4 standard is greater than that of a symbol for the H.264 standard.

The codec selecting unit 33 selects one of a plurality of codecs by referring to bit-lengths calculated by the bit length calculating unit 32. To be more specific, the codec selecting unit 33 selects a codec having a longest bit-length from among the bit-lengths which are of symbols for the plurality of codecs and which are calculated by the bit length calculating unit 32.

For example, as described above via the case in which examples of a plurality of codecs are the MPEG-4 and H.264 standards, the bit-length of the symbol for the MPEG-4 standard is greater than that of the symbol for the H.264 standard, and thus, the codec selecting unit 33 selects the MPEG-4 standard as a codec that is used to determine a storage capacity of an internal memory. In this manner, the embodiment of FIG. 3 selects a codec having a longer bit-length from among a plurality of codecs, and determines a storage capacity of an internal memory according to the selected codec so that a table for a codec having a shorter bit-length may share the internal memory.

The memory storage capacity determining unit 34 refers to a maximum level of each group of a plurality of groups that are clustered by the clustering unit 31, and refers to a bit-length of a symbol for a codec selected by the codec selecting unit 33, thereby determining a storage capacity of an internal memory.

Referring back to FIGS. 7A and 7B, checking maximum levels of each of groups obtained by clustering variable length code tables for the MPEG-4 standard, the maximum levels of groups obtained by clustering B16 are respectively 5, 5, 5, 5, 4 and 4, and the maximum levels of groups obtained by clustering B17 are respectively 5, 5, 5, 5, 4 and 4. Here, the number of groups, in which 5 is a maximum level, is 8, and the number of groups in which 4 is a maximum level is 4. Thus, considering that the bit-length of the symbol for the MPEG-4 standard is 13, eight RAM modules each having a size of 13×32(=2⁵), and four RAM modules each having a size of 13×16(=2⁴) are required for the multi-codec so as to support the MPEG-4 standard.

Referring back to FIGS. 8A through 8C, checking maximum levels of each of groups obtained by clustering variable length code tables for the H.264 standard, the maximum levels of groups obtained by clustering the 9.5 VLC0 are respectively 5, 5, 4 and 4, the maximum levels of groups obtained by clustering the 9.5 VLC1 are respectively 5, 5, 4, 4 and 3, and the maximum levels of groups obtained by clustering the 9.5 VLC2 are respectively 5, 5, 3 and 5. Here, the number of groups, in which 5 is a maximum level, is 7, the number of groups in which 4 is a maximum level is 4, and the number of groups in which 3 is a maximum level is 2. Thus, considering that the bit-length of the symbol for the H.264 standard is 9, seven RAM modules each having a size of 9×32(=2⁵), four RAM modules each having a size of 9×16(=2⁴), and two RAM modules each having a size of 9×8(=2³) are required for the multi-codec so as to support the H.264 standard.

The codec selecting unit 33 selects the MPEG-4 standard that has a longer bit-length, and a bit-length of the symbol for the MPEG-4 standard is 13. Thus, the memory storage capacity determining unit 34 determines the storage capacity of the internal memory 20 to include eight RAM modules each having a size of 13×32(=2⁵), four RAM modules each having a size of 13×16(=2⁴), and two RAM modules each having a size of 13×8(=2³). By doing so, the internal memory 20 may load all Huffman code tables for the MPEG-4 and H.264 standards so that the multi-codec including the internal memory 20 may support the MPEG-4 and H.264 standards.

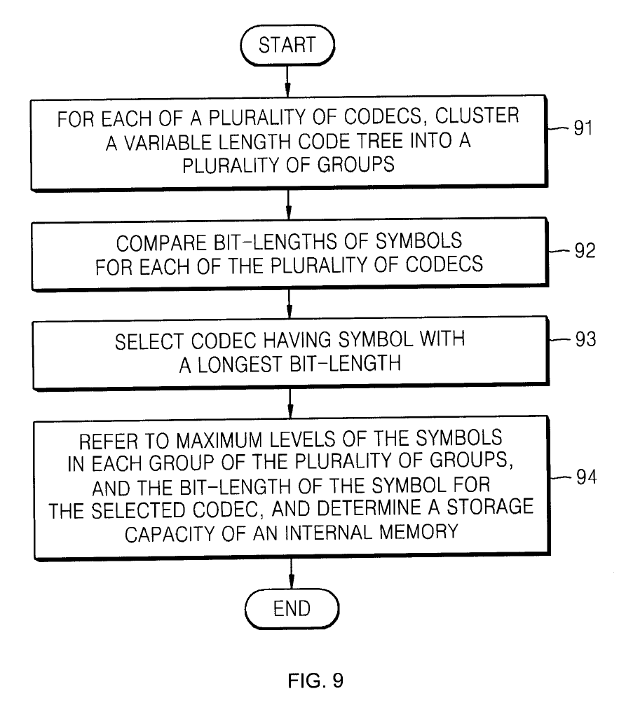

FIG. 9 is a flowchart of a method of sharing a memory of a multi-codec, according to another embodiment of the present disclosure.

Referring to FIG. 9, the method of sharing the memory of the multi-codec according to the embodiment of FIG. 9 includes operations that are performed in chronological order by a multi-codec memory sharing apparatus of FIG. 3. Thus, descriptions, which have previously been given in relation to the multi-codec memory sharing apparatus of FIG. 3, can be applied to the method of sharing the memory of the multi-codec according to the embodiment of FIG. 9, although some of the descriptions are omitted here.

In operation 91, for each of a plurality of codecs, the clustering unit 31 clusters a variable length code tree into a plurality of groups so that a level difference between symbols in each group is less than a predetermined value, wherein the variable length code tree corresponds to at least one of variable length code tables for each codec. In the embodiment of FIG. 9, the clustering unit 31 may cluster the variable length code tree into the plurality of groups so that the level difference between the symbols in each group is equal to or less than 1.

Also, in the embodiment of FIG. 9, for each of the plurality of codecs, the clustering unit 31 may cluster the variable length code tree corresponding to at least one of the variable length code tables into a plurality of first groups by using a first clustering mode, may cluster the variable length code tree into a plurality of second groups by using a second clustering mode, may compare overall efficiency of the first groups with overall efficiency of the second groups, and thus may select one from among the first groups and the second groups according to a result of the comparison.

In operation 92, the bit length calculating unit 32 compares bit-lengths of symbols for each of the plurality of codecs.

In operation 93, the codec selecting unit 33 selects a codec having a symbol with a longest bit-length.

In operation 94, the memory storage capacity determining unit 34 refers to maximum levels of the symbols in each group of the plurality of groups, and determines a storage capacity of an internal memory shared between the variable length code tables for each of the plurality of codecs. To be more specific, the memory storage capacity determining unit 34 refers to the maximum levels of the symbols in each group of the plurality of groups and refers to the bit-length of the symbol for the selected codec, thereby determining the storage capacity of the internal memory.

According to the embodiments of the present disclosure, the multi-codec clusters the variable length code tree corresponding to the variable code table into the plurality of groups so that the level difference between the symbols in each group is less than the predetermined value. By doing so, the cycle required to search for the symbol can be constant in each group, and power consumption used for searching for the symbol can be reduced so that the multi-codec can decode data with a fast and constant decoding speed.

Also, since the multi-codec clusters the variable length code tree corresponding to the variable code table into the plurality of groups, storage space is reduced so that memory efficiency can be enhanced. Also, the codeword length can be achieved from the index of each group, thus, it is not necessary to separately store the codeword length.

Moreover, the variable length code tables for each of the plurality of codecs in the multi-codec can share one internal memory so that the hardware size can be reduced.

The disclosure can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application.

What is claimed is:

1. A method of sharing a memory of a multi-codec, the method comprising:
for each of a plurality of codecs, clustering a variable length code tree into a plurality of groups whereby a level difference between symbols in each group of the plurality of groups is less than a predetermined value, wherein the variable length code tree corresponds to at least one of variable length code tables for each of the plurality of codecs; and
referring to maximum levels of the symbols in each group of the plurality of groups, and determining a storage capacity of an internal memory shared between the variable length code tables for the plurality of codecs.

2. The method of claim 1, wherein, in the clustering of the variable length code tree, the level difference is equal to or less than 1.

3. The method of claim 1, wherein the clustering of the variable length code tree comprises:
generating a plurality of clustering modes for the variable length code tree;
comparing an overall efficiency of each of the plurality of clustering modes; and
selecting one of the plurality of clustering modes according to a result of the comparing.

4. The method of claim 3, wherein the overall efficiency is a value obtained by dividing the total number of symbols in a plurality of relevant groups by a total storage capacity of the plurality of relevant groups.

5. The method of claim 4, wherein the total storage capacity is calculated based on maximum levels of the symbols in the plurality of relevant groups.

6. The method of claim 1, further comprising:
comparing bit-lengths of the symbols for each of the plurality of codecs; and
selecting a codec having a_symbol with a longest bit-length from among the bit-lengths according to a result of the comparing.

7. The method of claim 6, wherein the determining of the storage capacity comprises referring to the maximum levels of the symbols in each group of the plurality of groups and referring to the bit-length of the symbol for the selected codec, thereby determining the storage capacity of the internal memory.

8. A computer readable recording medium having recorded thereon a program for executing a method of sharing a memory of a multi-codec, the method comprising:
for each of a plurality of codecs, clustering a variable length code tree into a plurality of groups whereby a level difference between symbols in each group of the plurality of groups is less than a predetermined value, wherein the variable length code tree corresponds to at least one of variable length code tables for each of the plurality of codecs; and
referring to maximum levels of the symbols in each group of the plurality of groups, and determining a storage capacity of an internal memory shared between the variable length code tables for the plurality of codecs.

9. A multi-codec memory sharing apparatus, comprising:
a clustering unit, for each of a plurality of codecs, to cluster a variable length code tree into a plurality of groups whereby a level difference between symbols in each group of the plurality of groups is less than a predetermined value, wherein the variable length code tree corresponds to at least one of variable length code tables for each of the plurality of codecs; and
a memory storage capacity determining unit to refer to maximum levels of the symbols in each group of the plurality of groups, and to determine a storage capacity of an internal memory shared between the variable length code tables for the plurality of codecs.

10. The multi-codec memory sharing apparatus of claim 9, wherein the clustering unit clusters the variable length code tree into the plurality of groups whereby the level difference between the symbols in each group of the plurality of groups is equal to or less than 1.

11. The multi-codec memory sharing apparatus of claim 9, wherein the clustering unit generates a plurality of clustering modes for the variable length code tree, compares an overall efficiency of each of the plurality of clustering modes, and selects one of the plurality of clustering modes according to a result of the comparison.

12. The multi-codec memory sharing apparatus of claim 11, wherein the overall efficiency is a value obtained by dividing the total number of symbols in a plurality of relevant groups by a total storage capacity of the plurality of relevant groups.

13. The multi-codec memory sharing apparatus of claim 12, wherein the total storage capacity is calculated based on maximum levels of the symbols in the plurality of relevant groups.

14. The multi-codec memory sharing apparatus of claim 9, further comprising:
a bit length calculating unit to compare bit-lengths of the symbols for each of the plurality of codecs; and
a codec selecting unit to select a codec having a symbol with a longest bit-length from among the bit-lengths according to a result of the comparing.

15. The multi-codec memory sharing apparatus of claim 14, wherein the memory storage capacity determining unit refers to the maximum levels of the symbols in each group of the plurality of groups and refers to the bit-length of the symbol for the selected codec, thereby determining the storage capacity of the internal memory.

16. A method of clustering a variable length code table, the method comprising:
selecting a variable length code table from among a plurality of variable length code tables; and
clustering a variable length code tree into a plurality of groups whereby a level difference between symbols in each group of the plurality of groups is less than a predetermined value, wherein the variable length code tree corresponds to the selected variable length code table.

17. The method of claim 16, further comprising referring to the plurality of groups and determining a storage capacity of a memory for storing the plurality of variable length code tables.

18. The method of claim 16, wherein, in the clustering of the variable length code tree, the level difference is equal to or less than 1.

19. The method of claim 16, wherein the clustering of the variable length code tree comprises:
generating a plurality of clustering modes for the variable length code tree;
comparing overall efficiency of each of the plurality of clustering modes; and
selecting one of the plurality of clustering modes according to a result of the comparing.

20. The method of claim 16, wherein the variable length code table is a Huffman code table.
